(19) United States
(12) Patent Application Publication
(10) Pub. No.: US 2023/0144236 A1
(43) Pub. Date: May 11, 2023

(54) POSITION/FORCE CONTROL SYSTEM, POSITION/FORCE CONTROL APPARATUS, POSITION/FORCE CONTROL METHOD, AND STORAGE MEDIUM

(71) Applicants: TOYOTA BOSHOKU KABUSHIKI KAISHA, Aichi-ken (JP); KEIO UNIVERSITY, Tokyo (JP); Motion Lib, Inc., Kanagawa (JP)

(72) Inventors: Koji KANEDA, Aichi-ken (JP); Kouhei OHNISHI, Kanagawa-ken (JP); Takahiro MIZOGUCHI, Kanagawa-ken (JP); Genki KOKUBUN, Kanagawa-ken (JP)

(73) Assignees: TOYOTA BOSHOKU KABUSHIKI KAISHA, Aichi-ken (JP); KEIO UNIVERSITY, Tokyo (JP); Motion Lib, Inc., Kanagawa (JP)

(21) Appl. No.: 17/982,205

(22) Filed: Nov. 7, 2022

(30) Foreign Application Priority Data
Nov. 8, 2021 (JP) 2021-182220

(51) Int. Cl. A61H 7/00; H04L 67/141

(52) U.S. Cl. CPC A61H 7/004; H04L 67/141; H04L 67/12

(57) ABSTRACT

- - - A position/force control system includes one or multiple masterprimary apparatuses that receive an input of a treatment operation, one or multiple secondary apparatuses that output a treatment operation, and a control device that controls the one or multiple primary apparatuses and the one or multiple secondary apparatuses. The control device transmits a control parameter for causing the one or multiple secondary apparatusesto output force tactile sensation that corresponds to the treatment operation that is inputted into the one or multiple masterprimary apparatuses to the one or multiple secondary apparatuses and transmits a control parameter for causing the one or multiple masterprimary apparatuses to output reaction force against the treatment operation that is outputted by the one or multiple secondary apparatuses to the one or multiple primary apparatuses.- - -

### CROSS-REFERENCE TO RELATED APPLICATIONS

This application is based upon and claims the benefit of priority under 35 USC 119 of Japanese Patent Application No. 2021-182220 filed on Nov. 8, 2021 the entire disclosure of which, including the description, claims, drawings, and abstract, is incorporated herein by reference in its entirety.

### BACKGROUND OF THE INVENTION

### Field of the Invention

The present invention relates to a position/force control system, a position/force control apparatus, a position/force control method, and a storage medium.

### Description of the Related Art

A massage chair on which the body of a user is massaged is known.

For example, the massage chair has a function of massaging the back, shoulders, or another part of the user while moving a pressing member that is contained in a backrest and is improved in various ways so as to provide a massage similar to treatment that is provided by a practitioner such as a masseur.

Japanese Unexamined Patent Application Publication No. 2005-118126 discloses a technique regarding a massage machine that presumes the sense of a user about a massage operation and that controls and changes the massage operation in a direction that the user wishes, based on the presumed sense.

The technique disclosed in Japanese Unexamined Patent Application Publication No. 2005-118126 is used to provide an effective massage depending on the sense of the user that varies as the massage progresses and to improve the reliability of the presumed sense.

### BRIEF SUMMARY OF THE INVENTION

A position/force control system according to an aspect of the present invention comprising:
one or multiple master apparatuses that receive an input of a treatment operation;
one or multiple slave apparatuses that output a treatment operation; and
a controller that controls the one or multiple master apparatuses and the one or multiple slave apparatuses,
wherein the controller transmits a control parameter for causing the one or multiple slave apparatuses to output force tactile sensation that corresponds to the treatment operation that is inputted into the one or multiple master apparatuses to the one or multiple slave apparatuses and transmits a control parameter for causing the one or multiple master apparatuses to output reaction force against the treatment operation that is outputted by the one or multiple slave apparatuses to the one or multiple master apparatuses.

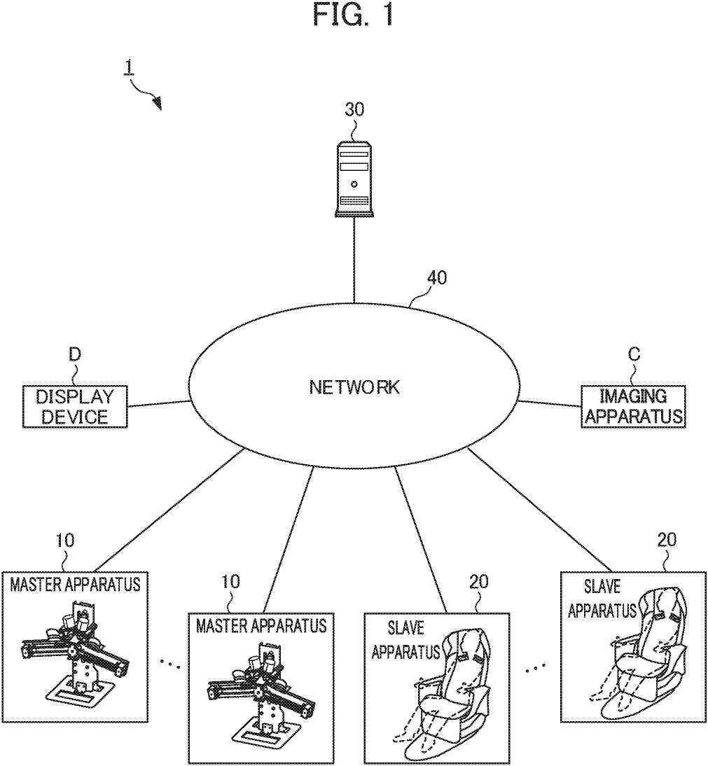

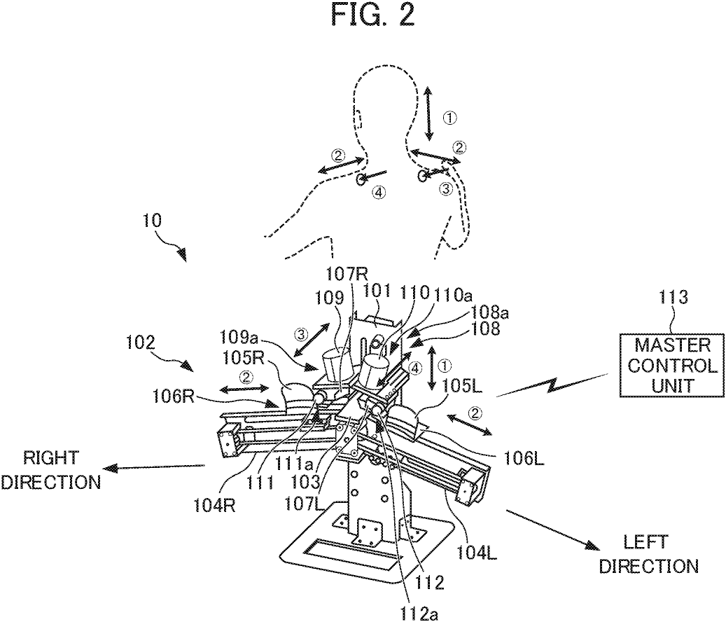

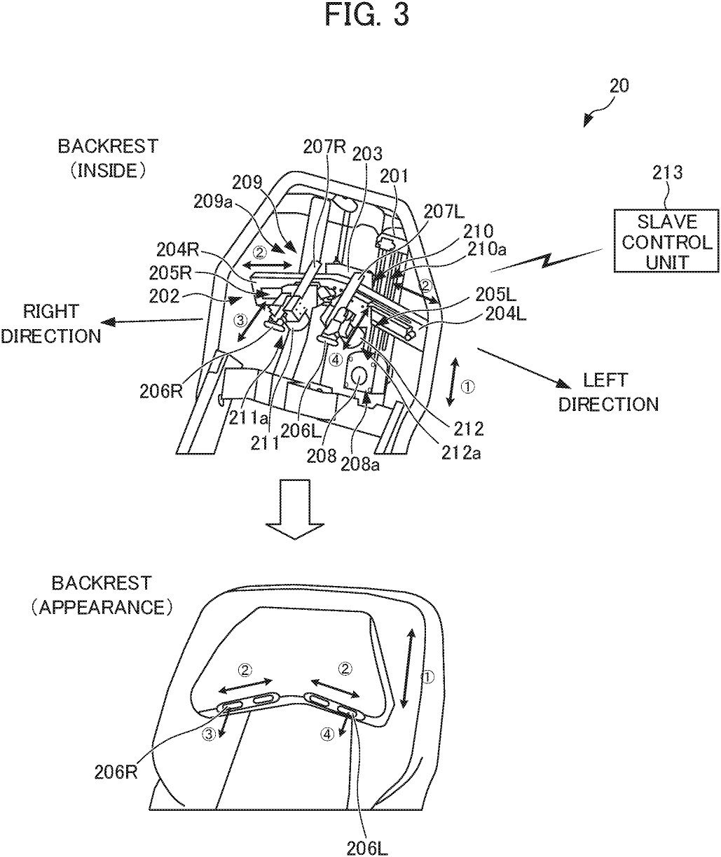

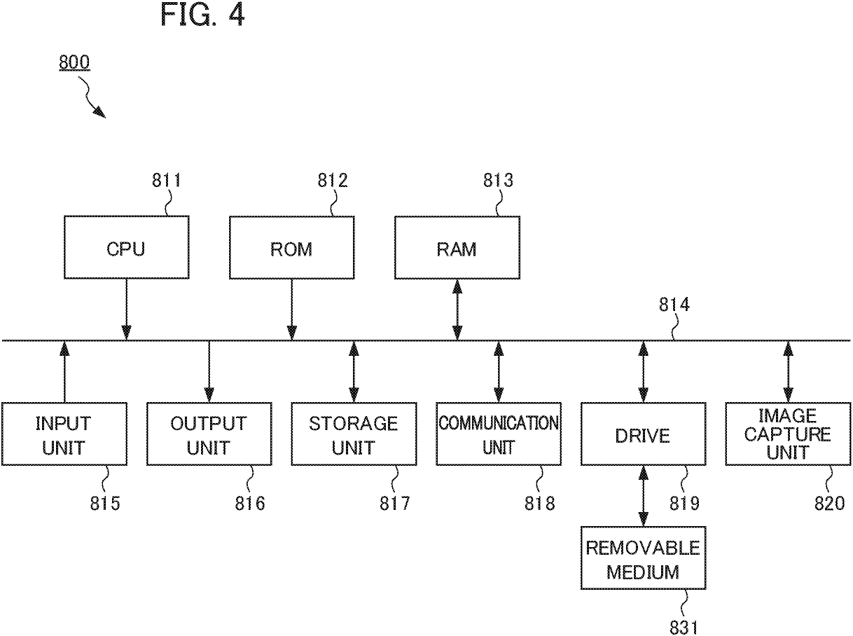

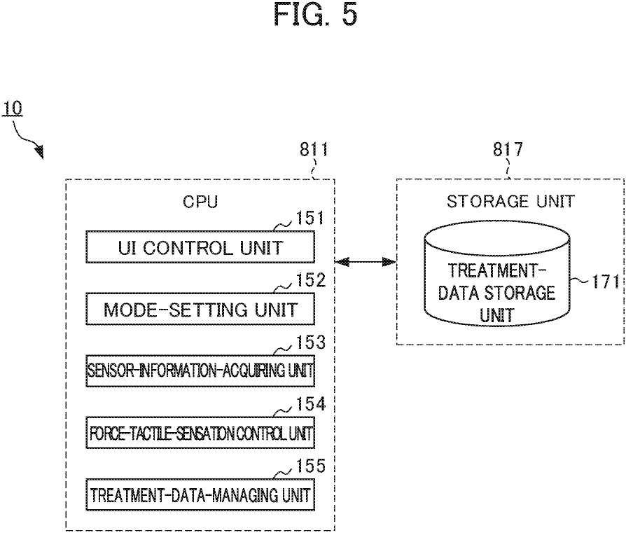

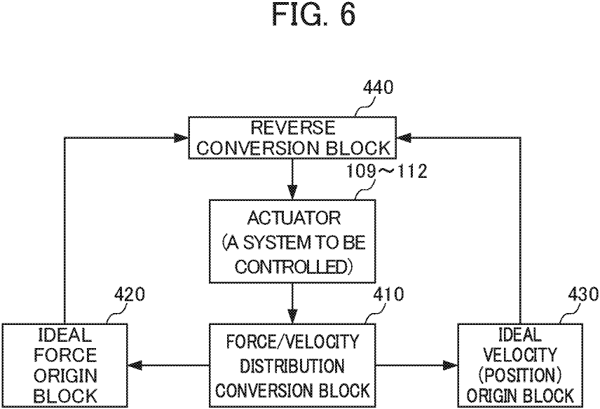

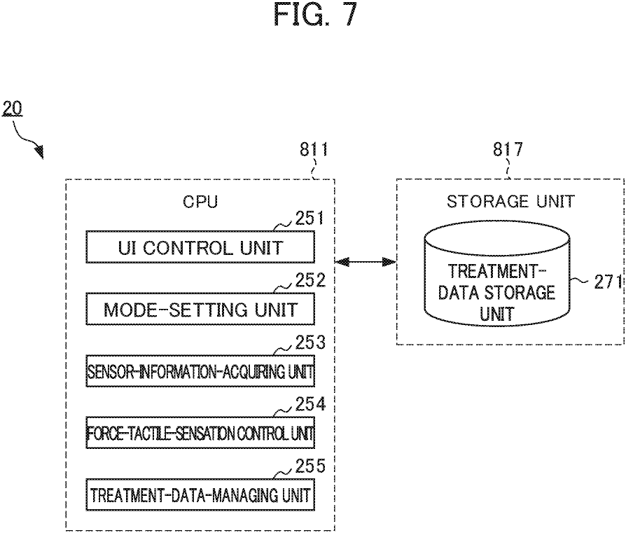

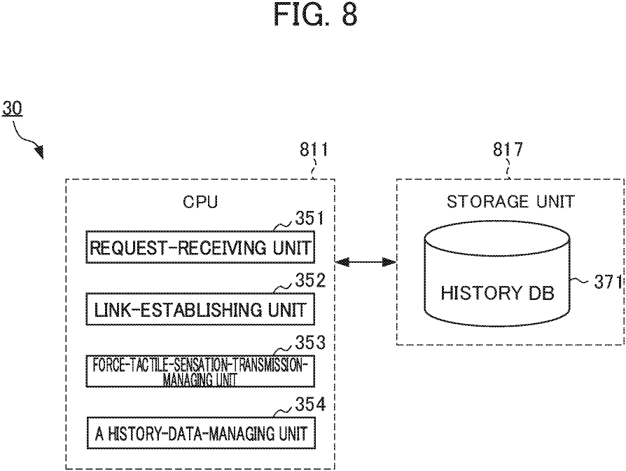

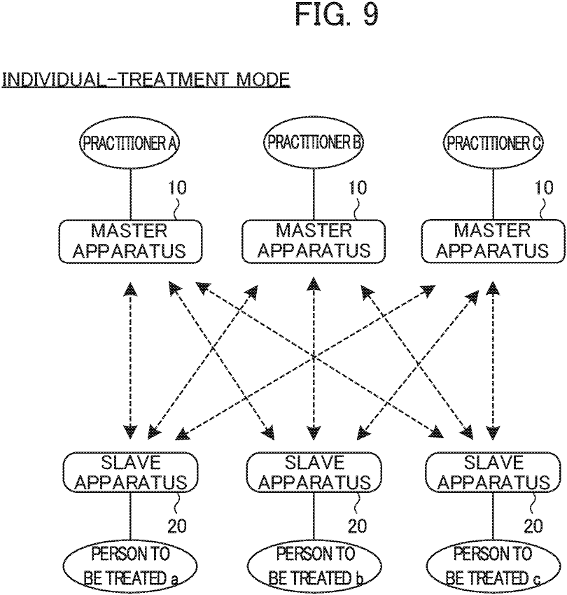

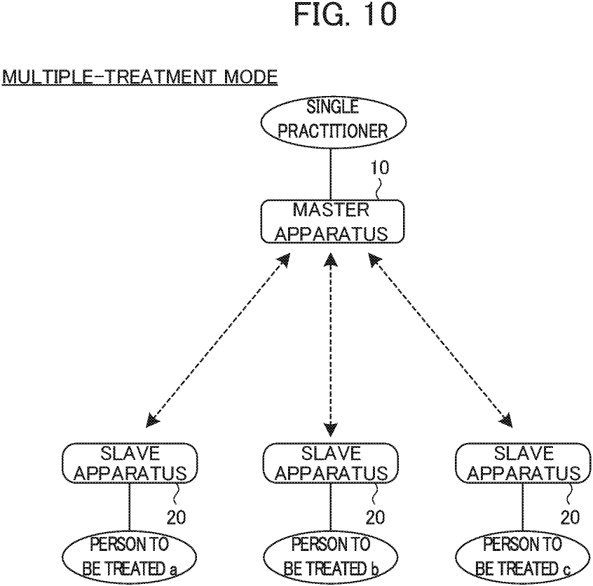

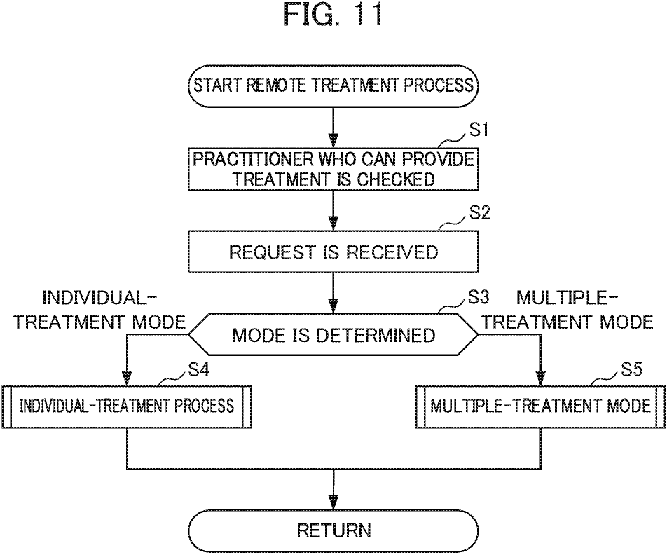

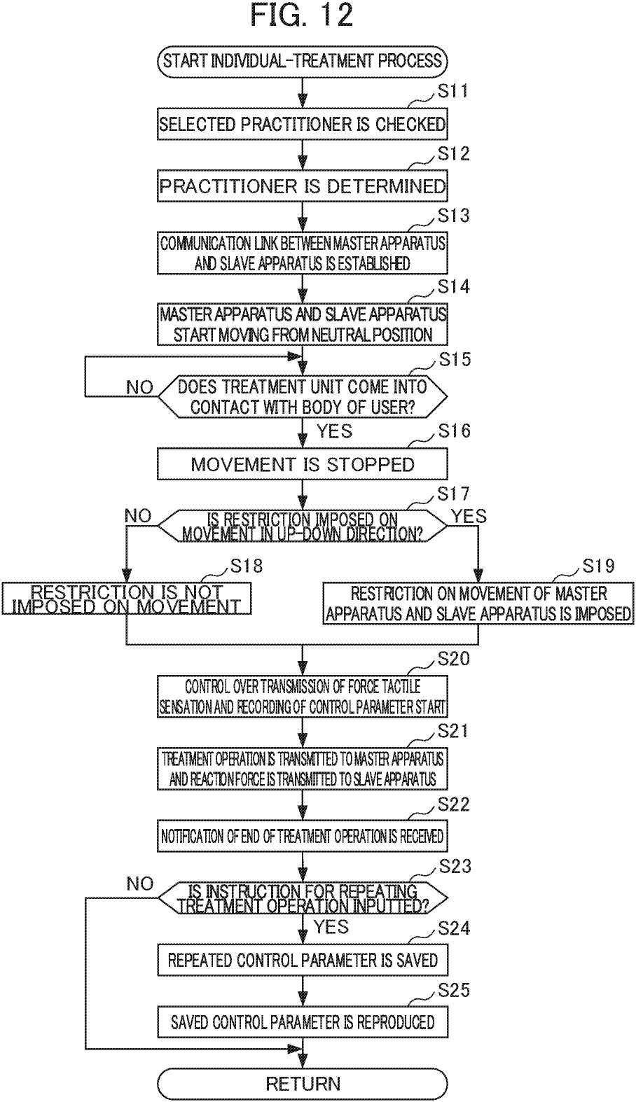

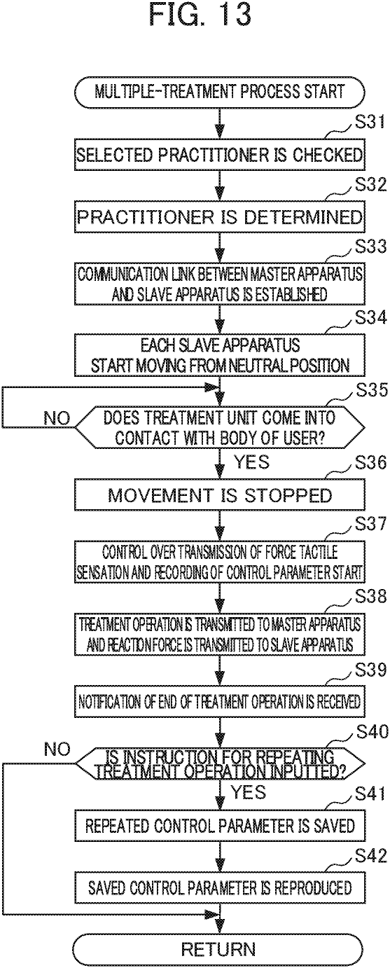

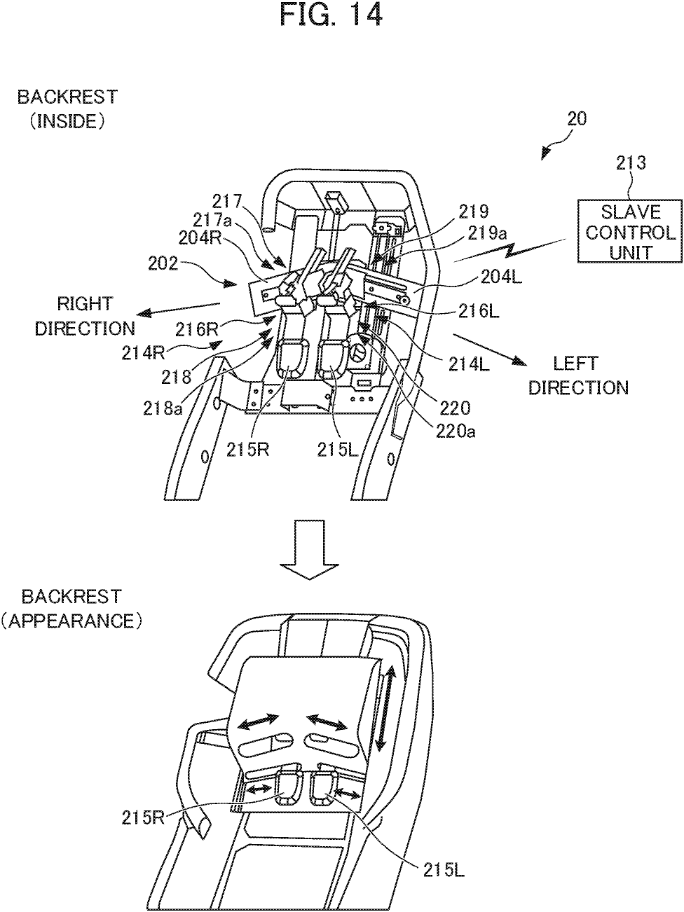

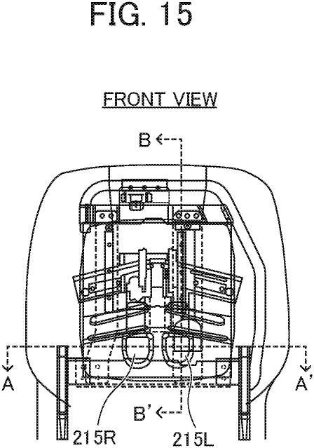

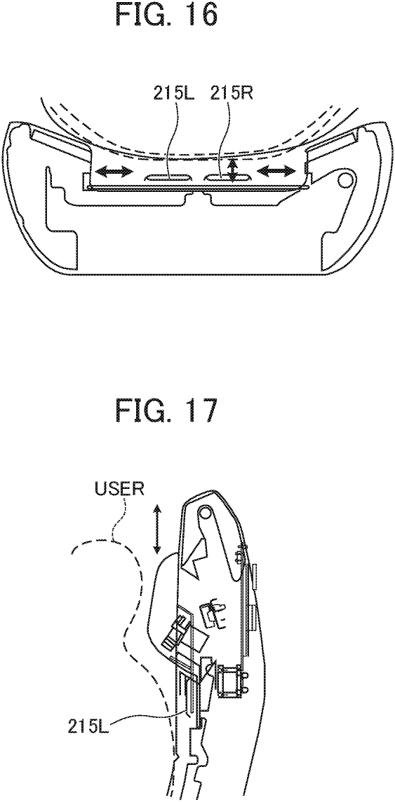

### BRIEF DESCRIPTION OF THE SEVERAL VIEWS OF THE DRAWING

[FIG. 1] FIG. 1 schematically illustrates the system configuration of a position/force control system 1 according to an embodiment of the present invention.

[FIG. 2] FIG. 2 schematically illustrates the structure of each of the master apparatuses 10.

[FIG. 3] FIG. 3 schematically illustrates the structure of each of the slave apparatuses 20.

[FIG. 4] FIG. 4 illustrates the hardware configuration of an information processing apparatus 800 that includes the functional unit for control in the position/force control system 1.

[FIG. 5] FIG. 5 is a block diagram illustrating the functional configuration of each master apparatus 10.

[FIG. 6] FIG. 6 is a block diagram illustrating an algorithm for control over the transmission of the force tactile sensation that is used according to the present embodiment.

[FIG. 7] FIG. 7 is a block diagram illustrating the functional configuration of each slave apparatus 20.

[FIG. 8] FIG. 8 is a block diagram illustrating the functional configuration of the control device 30.

[FIG. 9] FIG. 9 schematically illustrates the concept of the individual-treatment mode in the position/force control system 1.

[FIG. 10] FIG. 10 schematically illustrates the concept of the multiple-treatment mode in the position/force control system 1.

[FIG. 11] FIG. 11 is a flowchart illustrating the flow of the remote treatment process that is performed by the position/force control system 1.

[FIG. 12] FIG. 12 is a flowchart illustrating the flow of the individual-treatment process.

[FIG. 13] FIG. 13 is a flowchart illustrating the flow of the multiple-treatment process.

[FIG. 14] FIG. 14 schematically illustrates the structure of the slave apparatus 20 that has a function of rubbing the back of the user.

[FIG. 15] FIG. 15 is a front view of the slave apparatus 20 illustrated in FIG. 14.

[FIG. 16] FIG. 16 is a sectional view of the slave apparatus 20 taken along line A-A′ in FIG. 15.

[FIG. 17] FIG. 17 is a sectional view of the slave apparatus 20 taken along line B-B′ in FIG. 15.

### DETAILED DESCRIPTION OF THE INVENTION

An embodiment of the present invention will hereinafter be described with reference to the drawings.

### Structure

FIG. 1 schematically illustrates the system configuration of a position/force control system 1 according to an embodiment of the present invention.

As for the position/force control system 1 according to the present embodiment, multiple master apparatuses 10 that are used by practitioners and multiple slave apparatuses 20 that are used by users are remotely located, and a communication link can be established between a combination of a freely selected one of the master apparatuses 10 and a freely selected one of the slave apparatuses 20. The master apparatuses 10 receive treatment operations that are performed by the practitioners. The slave apparatuses 20 enable the users (people to be treated) to receive the treatment operations that are performed by the practitioners. Transmission of force tactile sensation between the master apparatuses 10 and the slave apparatuses 20 is controlled, the treatment operations that are performed by the practitioners by using the master apparatuses 10 are consequently inputted into the users by using the slave apparatuses 20, and reaction force that is inputted from the users into the slave apparatuses 20 is provided to the practitioners by using the master apparatuses 10.

Accordingly, a massage device can provide tactility similar to that in the case where the practitioners directly massage the users.

As illustrated in FIG. 1, the position/force control system 1 according to the present embodiment includes the master apparatuses 10 that receive the treatment (such as massages) operations that are inputted by the practitioners, the slave apparatuses 20 that output the treatment operations to the users (people to be treated), a control device 30 that controls the transmission of the force tactile sensation between the master apparatuses 10 and the slave apparatuses 20, imaging apparatuses C that image the users to be treated by the slave apparatuses 20, and display devices D that display the images of the users that are captured by the imaging apparatus C. The master apparatuses 10, the slave apparatuses 20, the control device 30, the imaging apparatus C, and the display devices D can communicate with each other via a network 40 such as the internet. According to the present embodiment, the position/force control system 1 includes the multiple master apparatuses 10, the multiple slave apparatuses 20, the multiple imaging apparatuses C, and the multiple display devices D.

The master apparatuses 10 include mechanisms that receive the treatment operations that are inputted by the practitioners, and members (right-hand pressure-receiving members 106R and left-hand pressure-receiving member 106L described later) that receive the pressing operations of the practitioners are movable in an up-down direction (the spine direction of each user), in a left-right direction (the shoulder width direction of each user), and in a front-rear direction (a direction in which the body of each user is pressed). According to the present embodiment, the master apparatuses 10 have a structure following the shape of a human being near the shoulders and the neck and can receive movement when the practitioners actually treat people to be treated.

FIG. 2 schematically illustrates the structure of each of the master apparatuses 10.

In FIG. 2, the upper body of a person to be treated by using the master apparatus 10 is also schematically illustrated, and enclosed numbers and arrows represent corresponding movement at the upper body of the person to be treated and the master apparatus 10.

As illustrated in FIG. 2, the master apparatus 10 includes a base portion 101 that serves as the base of the entire master apparatus 10, a pressure-receiving unit 102 that is movable in the up-down direction with respect to the base portion 101, a front-rear arm 103 that extends in the front-rear direction in the pressure-receiving unit 102, a right-hand arm portion 104R and a left-hand arm portion 104L that are installed at ends of the front-rear arm 103 and that extend in the left-right direction, a right-hand operation portion 105R that is movable in the left-right direction at the right-hand arm portion 104R, and a left-hand operation portion 105L that is movable in the left-right direction at the left-hand arm portion 104L. The right-hand operation portion 105R includes the right-hand pressure-receiving member 106R that receives the pressing operation of the practitioner and a right-hand support member 107R that supports the right-hand pressure-receiving member 106R such that the right-hand pressure-receiving member 106R is movable in the front-rear direction. The left-hand operation portion 105L includes the left-hand pressure-receiving member 106L that receive the pressing operation of the practitioner and a left-hand support member 107L that supports the left-hand pressure-receiving member 106L such that the left-hand pressure-receiving member 106L is movable in the front-rear direction.

An actuator 108 can control the movement of the pressure-receiving unit 102 in the up-down direction. As for the movement of the right-hand operation portion 105R and the left-hand operation portion 105L in the left-right direction and the movement of the right-hand pressure-receiving member 106R and the left-hand pressure-receiving member 106L in the front-rear direction, actuators 109 to 112 can apply reaction force.

The master apparatus 10 also includes a master control unit 113 that controls the master apparatus 10 in accordance with the control of the control device 30.

The base portion 101 is a support member that serves as the base of the entire master apparatus 10 and supports the pressure-receiving unit 102 such that the pressure-receiving unit 102 is movable in the up-down direction. The actuator 108 changes the position of the pressure-receiving unit 102 in the up-down direction and enables the pressure-receiving unit 102 to be fixed at a target position.

The pressure-receiving unit 102 is movable in the up-down direction with respect to the base portion 101, and the front-rear arm 103, the right-hand arm portion 104R, the left-hand arm portion 104L, the right-hand operation portion 105R, and the left-hand operation portion 105L are installed. That is, the pressure-receiving unit 102 moves in the up-down direction, and the positions of the front-rear arm 103, the right-hand arm portion 104R, the left-hand arm portion 104L, the right-hand operation portion 105R, and the left-hand operation portion 105L in the up-down direction consequently change.

The front-rear arm 103 is a member that extends in the front-rear direction and is installed in the pressure-receiving unit 102, and the right-hand arm portion 104R and the left-hand arm portion 104L are fixed at the ends. The inclination of the right-hand arm portion 104R and the left-hand arm portion 104L with respect to the horizontal direction may be adjustable.

The right-hand arm portion 104R is installed at one of the ends of the front-rear arm 103 and extends in the right-hand direction from the front-rear arm 103. The right-hand arm portion 104R supports the right-hand operation portion 105R such that the right-hand operation portion 105R is movable in the left-right direction. The position of the right-hand operation portion 105R in the left-right direction changes due to the treatment operation of the practitioner.

The left-hand arm portion 104L is installed at the other end of the front-rear arm 103 and extends in the left-hand direction from the front-rear arm 103. The left-hand arm portion 104L supports the left-hand operation portion 105L such that the left-hand operation portion 105L is movable in the left-right direction. The position of the left-hand operation portion 105L in the left-right direction changes due to the treatment operation of the practitioner.

The right-hand operation portion 105R is movable in the left-right direction with respect to the right-hand arm portion 104R and includes the right-hand support member 107R that supports the right-hand pressure-receiving member 106R such that the right-hand pressure-receiving member 106R is movable in the front-rear direction. The right-hand pressure-receiving member 106R receives the pressing operation of the practitioner who treats the user and moves in the front-rear direction with respect to the right-hand support member 107R. The position of the right-hand pressure-receiving member 106R in the front-rear direction changes due to the pressing operation of the practitioner.

The left-hand operation portion 105L is movable in the left-right direction with respect to the left-hand arm portion 104L and includes the left-hand support member 107L that supports the left-hand pressure-receiving member 106L such that the left-hand pressure-receiving member 106L is movable in the front-rear direction. The left-hand pressure-receiving member 106L receives the pressing operation of the practitioner who treats the user and moves in the front-rear direction with respect to the left-hand support member 107L. The position of the left-hand pressure-receiving member 106L in the front-rear direction changes due to the pressing operation of the practitioner.

The actuator 108 moves the pressure-receiving unit 102 in the up-down direction with respect to the base portion 101 in response to an operation of the practitioner or an instruction from the master control unit 113. The actuator 108 includes a rotary encoder 108a that detects the rotation angle of the rotor of the actuator 108. The rotation angle that is detected by the rotary encoder 108a is transmitted to the master control unit 113.

The actuator 109 applies the reaction force against the movement of the right-hand operation portion 105R when the right-hand operation portion 105R moves in the left-right direction due to the treatment operation of the practitioner. The actuator 109 includes a rotary encoder 109a that detects the rotation angle of the rotor of the actuator 109. The rotation angle that is detected by the rotary encoder 109a is transmitted to the master control unit 113.

The actuator 110 applies the reaction force against the movement of the left-hand operation portion 105L when the left-hand operation portion 105L moves in the left-right direction due to the treatment operation of the practitioner. The actuator 110 includes a rotary encoder 110a that detects the rotation angle of the rotor of the actuator 110. The rotation angle that is detected by the rotary encoder 110a is transmitted to the master control unit 113.

The actuator 111 applies the reaction force against the movement of the right-hand pressure-receiving members 106R when the right-hand pressure-receiving members 106R moves in the front-rear direction due to the treatment operation of the practitioner. The actuator 111 includes a rotary encoder 111a that detects the rotation angle of the rotor of the actuator 111. The rotation angle that is detected by the rotary encoder 111a is transmitted to the master control unit 113.

The actuator 112 applies the reaction force against the movement of the left-hand pressure-receiving member 106L when the left-hand pressure-receiving member 106L moves in the front-rear direction due to the treatment operation of the practitioner. The actuator 112 includes a rotary encoder 112a that detects the rotation angle of the rotor of the actuator 112. The rotation angle that is detected by the rotary encoder 112a is transmitted to the master control unit 113.

The master control unit 113 controls the actuators 108 to 112 of the master apparatus 10 in accordance with the control of the control device 30 and transmits the rotation angles of the actuators 108 to 112 that are detected by the rotary encoders 108a to 112a to the control device 30.

The slave apparatuses 20 include mechanisms that output the treatment operations to the users (people to be treated), and members (right-hand pressing members 206R and left-hand pressing members 206L described later) that output the pressing operations for the treatment to the users are movable in the up-down direction (the spine direction of each user), in the left-right direction (the shoulder width direction of each user), and in the front-rear direction (the direction in which the body of each user is pressed).

The slave apparatuses 20 include the mechanisms that output the treatment operations to the users (people to be treated), and the members (the right-hand pressing members 206R and the left-hand pressing members 206L described later) that output the pressing operations to the users are movable in the up-down direction (the spine direction of each user), in the left-right direction (the shoulder width direction of each user), and in the front-rear direction (the direction in which the body of each user is pressed). The slave apparatuses 20 can be installed for various kinds of equipment that can provide massages to the users such as a chair, a sofa, a bed, and a seat of an automobile.

FIG. 3 schematically illustrates the structure of each of the slave apparatuses 20.

In FIG. 3, the appearance of a part of a backrest in which the mechanical structure of the slave apparatus 20 is mounted inside is also illustrated, and enclosed numbers and arrows represent movement similar to the movement of the master apparatus 10 illustrated in FIG. 2.

As illustrated in FIG. 3, the slave apparatus 20 includes a support portion 201 that supports the entire slave apparatus 20, a treatment unit 202 that is movable in the up-down direction with respect to the support portion 201, a base portion 203 that serves as a base member that supports the treatment unit 202, a right-hand arm portion 204R and a left-hand arm portion 204L that are installed in the base portion 203 and that extend in the left-right direction, a right-hand action portion 205R that is movable in the left-right direction at the right-hand arm portion 204R, and a left-hand action portion 205L that is movable in the left-right direction at the left-hand arm portion 204L. The right-hand action portion 205R includes the right-hand pressing member 206R that presses the user, and a right-hand support member 207R that supports the right-hand pressing member 206R such that the right-hand pressing member 206R is movable in the front-rear direction. The left-hand action portion 205L includes the left-hand pressing member 206L that presses the user and a left-hand support member 207L that supports the left-hand pressing member 206L such that the left-hand pressing member 206L is movable in the front-rear direction.

An actuator 208 can control the movement of the treatment unit 202 in the up-down direction. Actuators 209 to 212 can control the movement of the right-hand action portion 205R and the left-hand action portion 205L in the left-right direction and the movement of the right-hand pressing member 206R and the left-hand pressing member 206L in the front-rear direction.

The slave apparatus 20 also includes a slave control unit 213 that controls the slave apparatus 20 in accordance with the control of the control device 30.

The support portion 201 is a support member that supports the entire slave apparatus 20 and supports the treatment unit 202 such that the treatment unit 202 is movable in the up-down direction. The actuator 208 changes the position of the treatment unit 202 in the up-down direction and enables the treatment unit 202 to be fixed at a target position.

The treatment unit 202 is movable in the up-down direction with respect to the support portion 201, and the base portion 203, the right-hand arm portion 204R, the left-hand arm portion 204L, the right-hand action portion 205R, and the left-hand action portion 205L are installed. That is, the treatment unit 202 moves in the up-down direction, and the positions of the right-hand arm portion 204R, the left-hand arm portion 204L, the right-hand action portion 205R, and the left-hand action portion 205L in the up-down direction consequently change.

The base portion 203 is a base member that supports the treatment unit 202 and supports the treatment unit 202 such that the treatment unit 202 is movable in the up-down direction. The actuator 208 changes the position of the treatment unit 202 in the up-down direction and enables the treatment unit 202 to be fixed at a target position.

The right-hand arm portion 204R is installed in the base portion 203 and extends in the right-hand direction (more specifically, a lower right-hand direction parallel to typical shoulder inclination) from the base portion 203. The right-hand arm portion 204R supports the right-hand action portion 205R such that the right-hand action portion 205R is movable in the left-right direction. The position of the right-hand action portion 205R in the left-right direction changes in accordance with reference values of position and force that are transmitted from the control device 30 depending on the treatment operation of the practitioner.

The left-hand arm portion 204L is installed in the base portion 203 and extends in the left-hand direction (more specifically, a lower left-hand direction parallel to the typical shoulder inclination) from the base portion 203. The left-hand arm portion 204L supports the left-hand action portion 205L such that the left-hand action portion 205L is movable in the left-right direction. The position of the left-hand action portion 205L in the left-right direction changes in accordance with the reference values of position and force that are transmitted from the control device 30 depending on the treatment operation of the practitioner.

The right-hand action portion 205R is movable in the left-right direction with respect to the right-hand arm portion 204R and includes the right-hand support member 207R that supports the right-hand pressing member 206R such that the right-hand pressing member 206R is movable in the front-rear direction. The right-hand pressing member 206R presses the user in accordance with the reference values of position and force that are transmitted from the control device 30 depending on the pressing operation of the practitioner and moves in the front-rear direction with respect to the right-hand support member 207R. That is, the position of the right-hand pressing members 206R in the front-rear direction changes due to the pressing operation of the practitioner.

The left-hand action portion 205L is movable in the left-right direction with respect to the left-hand arm portion 204L and includes the left-hand support member 207L that supports the left-hand pressing member 206L such that the left-hand pressing member 206L is movable in the front-rear direction. The left-hand pressing members 206L presses the user in accordance with the reference values of position and force that are transmitted from the control device 30 depending on the pressing operation of the practitioner and moves in the front-rear direction with respect to the left-hand support member 207L. That is, the position of the left-hand pressing members 206L in the front-rear direction changes due to the pressing operation of the practitioner.

The actuator 208 moves the treatment unit 202 in the up-down direction with respect to the support portion 201 in response to an operation of the user or an instruction from the slave control unit 213. In the case where the treatment unit 202 moves in the up-down direction in response to the instruction from the slave control unit 213, the reaction force that is inputted into the right-hand action portion 205R and the left-hand action portion 205L, for example, is detected, and the position at which the treatment unit 202 is fixed can be automatically adjusted so as to be suitable for the positions of the shoulders of the user. The actuator 208 includes a rotary encoder 208a that detects the rotation angle of the rotor of the actuator 208. The rotation angle that is detected by the rotary encoder 208a is transmitted to the slave control unit 213.

The actuator 209 moves the right-hand action portion 205R in the left-right direction in accordance with the reference values of position and force that are transmitted from the control device 30 depending on the treatment operation of the practitioner. The actuator 209 includes a rotary encoder 209a that detects the rotation angle of the rotor of the actuator 209. The rotation angle that is detected by the rotary encoder 209a is transmitted to the slave control unit 213.

The actuator 210 moves the left-hand action portion 205L in the left-right direction in accordance with the reference values of position and force that are transmitted from the control device 30 depending on the treatment operation of the practitioner. The actuator 210 includes a rotary encoder 210a that detects the rotation angle of the rotor of the actuator 210. The rotation angle that is detected by the rotary encoder 210a is transmitted to the slave control unit 213.

The actuator 211 moves the right-hand pressing member 206R in the front-rear direction in accordance with the reference values of position and force that are transmitted from the control device 30 depending on the treatment operation of the practitioner. Consequently, the right-hand pressing member 206R presses the user at and by the position and the force that correspond to those of the treatment operation of the practitioner. The actuator 211 includes a rotary encoder 211a that detects the rotation angle of the rotor of the actuator 211. The rotation angle that is detected by the rotary encoder 211a is transmitted to the slave control unit 213.

The actuator 212 moves the left-hand pressing member 206L in the front-rear direction in accordance with the reference values of position and force that are transmitted from the control device 30 depending on the treatment operation of the practitioner. Consequently, the left-hand pressing members 206L presses the user at and by the position and the force that correspond to those of the treatment operation of the practitioner. The actuator 212 includes a rotary encoder 212a that detects the rotation angle of the rotor of the actuator 212. The rotation angle that is detected by the rotary encoder 212a is transmitted to the slave control unit 213.

The slave control unit 213 controls the actuators 208 to 212 of the slave apparatus 20 in accordance with the control of the control device 30 and transmits the rotation angles of the actuators 208 to 212 that are detected by the rotary encoders 208a to 212a to the control device 30.

The control device 30 controls the transmission of the force tactile sensation between the master apparatuses 10 and the slave apparatuses 20. According to the present embodiment, the control device 30 associates a freely selected one of the master apparatuses 10 and a freely selected one of the slave apparatuses 20 with each other among the multiple master apparatuses 10 and the multiple slave apparatuses 20, and this enables a master-slave system to be dynamically provided. The control device 30 stores control parameters for transmitting the force tactile sensation when the practitioners treat the users by using the master apparatuses 10 and the slave apparatuses 20. The control device 30 transmits the stored control parameters to the slave apparatuses 20, and the treatment of the practitioners on the users can consequently be reproduced. At this time, the control device 30 can transmit the stored control parameters that are not edited to the slave apparatuses 20 (that is, the stored treatment is reproduced) and can transmit the stored+- control parameters that are edited, for example, the control parameters that are partly deleted, the control parameters that are partly repeated, or the control parameters in which the force is changed, to the slave apparatuses 20. Editing the control parameters enables the content of the treatment to be changed into one that the users prefer and enables the content of the treatment provided to a different user to be changed into one that is suitable for the body shapes or preference of the users to be treated.

The imaging apparatuses C image the users to be treated by using the slave apparatuses 20 and transmit the data of the captured images to the control device 30.

The display devices D receive the images of the users that are captured by the imaging apparatus C from the control device 30 and display the images of the users (people to be treated) for the practitioners that provide the treatment by using the master apparatuses 10.

### Hardware Configuration

The hardware configuration of a functional unit for control in the position/force control system 1 will now be described.

As for the position/force control system 1, the control device 30, the master control units 113, and the slave control units 213 are included in an information processing apparatus such as a personal computer (a PC), a server computer, or a tablet terminal and have the same basic structure.

FIG. 4 illustrates the hardware configuration of an information processing apparatus 800 that includes the functional unit for control in the position/force control system 1.

As illustrated in FIG. 4, the information processing apparatus 800 includes a CPU (Central Processing Unit) 811, a ROM (Read Only Memory) 812, a RAM (Random Access Memory) 813, a bus 814, an input unit 815, an output unit 816, a storage unit 817, a communication unit 818, a drive 819, and an image capture unit 820.

The CPU 811 executes various processing according to programs that are recorded in the ROM 812, or programs that are loaded from the storage unit 820 to the RAM 813.

The RAM 813 also stores data and the like necessary for the CPU 811 to execute the various processing, as appropriate.

The CPU 811, the ROM 812 and the RAM 813 are connected to one another via the bus 814. The input unit 815, the output unit 816, the storage unit 817, the communication unit 818, the drive 819 and the image capture unit 820 are connected to the bus 814.

The input unit 815 is configured by various buttons and the like, and inputs a variety of information in accordance with instruction operations by the user.

The output unit 816 is configured by the display unit, a speaker, and the like, and outputs images and sound.

Note that in the case where the information processing apparatus 800 is configured as a smart phone or a tablet terminal, a configuration provided with a touch panel is also possible by overlapping the input unit 815 with a display of the output unit 816.

The storage unit 817 is configured by DRAM (Dynamic Random Access Memory) or the like, and stores various data managed by each server.

The communication unit 818 controls communication with other devices via networks.

A removable medium 831 composed of a magnetic disk, an optical disk, a magneto-optical disk, semiconductor memory or the like is installed in the drive 819, as appropriate. Programs that are read via the drive 819 from the removable medium 831 are installed in the storage unit 817, as necessary.

The image capture unit 820, which is configured by using an imaging apparatus including a lens and an image sensor, captures digital images of subjects.

When the information processing apparatus 800 is configured as a server, the image capture unit 820 may be omitted. When the information processing apparatus 800 is configured as a tablet terminal, the input unit 815 may be configured by using a touch sensor which overlies the display of the output unit 816. Thus, the information processing apparatus 800 may have a configuration including a touch panel.

### Functional Configuration of Control System

The functional configuration of a control system of each apparatus of the position/force control system 1 will now be described.

### Functional Configuration of Master Apparatus 10

FIG. 5 is a block diagram illustrating the functional configuration of each master apparatus 10.

As for a CPU 811 of the master apparatus 10 (the master control unit 113), as illustrated in FIG. 5, a user interface control unit (a UI control unit) 151, a mode-setting unit 152, a sensor-information-acquiring unit 153, a force-tactile-sensation control unit 154, and a treatment-data-managing unit 155 function. A treatment-data storage unit 171 is formed in a storage unit 817 of the master apparatus 10.

The treatment-data storage unit 171 stores the control parameters in the treatment and information about the user who is treated by the practitioner by using the master apparatus 10. The information about the user who is treated by the practitioner includes attribution information such as the preference of the content of the treatment, the contact address, the gender, the age, and the name of the user. The control parameters in time series regarding the transmission of the force tactile sensation during the treatment of the practitioner are stored as the control parameters in the treatment.

The UI control unit 151 controls the display of various input and output screens in the process (a remote treatment process described later) for the practitioner who treats the user by using the position/force control system 1. For example, the UI control unit 151 receives a setting that represents whether an individual-treatment mode in which the practitioner treats the user in a one-to-one manner is activated, or a multiple-treatment mode in which the single practitioner treats multiple users is activated in the remote treatment process. The UI control unit 151 displays the images of the users that are transmitted from the control device 30 on, for example, the display devices D or a display of the output unit 816 that is included in the master apparatus 10.

The mode-setting unit 152 sets the mode that is activated in the remote treatment process. According to the present embodiment, the individual-treatment mode in which the practitioner treats the user in a one-to-one manner can be set, or the multiple-treatment mode in which the single practitioner treats the multiple users can be set, and the mode-setting unit 152 sets one of the modes in accordance with an input from the practitioner or an instruction from the control device 30.

The sensor-information-acquiring unit 153 acquires information about positions (the rotation angles of rotors) that are detected by the rotary encoders 108a to 112a of the actuators 108 to 112. According to the present embodiment, the actuators 109 to 112 of the master apparatus 10 involve in the transmission of the force tactile sensation, and accordingly, the sensor-information-acquiring unit 153 acquires the information about the positions (the rotation angles of the rotors) from the rotary encoders 109a to 112a at a rate that enables the treatment operation in the remote treatment process to be continuous and smooth, for example, in every 100 [ms]. The information about the positions (the rotation angles of the rotors) that is acquired from the rotary encoders 109a to 112a changes depending on the output (that is, an input from the body of the user into each slave apparatus 20) of each actuator and the treatment operation that is inputted by the practitioner.

The force-tactile-sensation control unit 154 controls the transmission of the force tactile sensation, based on the information about the positions (the rotation angles of the rotors) that is acquired by the sensor-information-acquiring unit 153 and the information about the positions (the rotation angles of the rotors) in the actuators of the slave apparatus 20 that is transmitted from the control device 30. That is, the force-tactile-sensation control unit 154 uses the information about the positions (the rotation angles of the rotors) in the actuators of the slave apparatus 20 as the reference values and uses the reference values and the information about the positions (the rotation angles of the rotors) that is acquired by the sensor-information-acquiring unit 153 as input data, and causes a target actuator in the master apparatus 10 to follow the operation (output of the position and the force) of the corresponding actuator in the slave apparatus 20.

FIG. 6 is a block diagram illustrating an algorithm for control over the transmission of the force tactile sensation that is used according to the present embodiment.

As illustrated in FIG. 6, the algorithm for the control over the transmission of the force tactile sensation is expressed as a control rule that includes a reverse conversion block 440, an ideal force origin block 420 or an ideal velocity (position) origin block 430, a force/velocity distribution conversion block 410, and the actuators 109 to 112 (a system to be controlled) . According to the present embodiment, the actuators 109 to 112 of the master apparatuses 10 and the actuators 209 to 212 of the slave apparatuses 20 are associated with each other in a one-to-one manner in the case where the remote treatment process is performed. For this reason, the algorithm described below relates to the control over the transmission of the force tactile sensation between a single actuator in the master apparatuses 10 and the corresponding actuator in the slave apparatuses 20.

A position and velocity (or acceleration) or an angle and angular velocity (or angular acceleration) are parameters that can be replaced by calculus. Accordingly, in the case where processing regarding the position or the angle is performed, these can be appropriately replaced with, for example, the velocity or the angular velocity. According to the present embodiment, the rotation angles of the rotors are used as information about the positions of the actuators, but another information may be used provided that the information represents physical quantities related to each other such as the position of a member that operates in conjunction with a rotor of an actuator.

The force/velocity distribution conversion block 410 defines coordinate transformation where a value (a reference value) on which the operations of the actuators 109 to 112 are based and the current positions of the rotation axes of the actuators 109 to 112 are inputted. The coordinate transformation includes conversion of an input vector, elements of which are the reference value and current velocity (or position) into an output vector that includes velocity (or position) for calculating a target control value for the velocity (or position) and conversion of an input vector, elements of which are the reference value and current force into an output vector that includes force for calculating a target control value for the force. Specifically, the coordinate transformation of the force/velocity distribution conversion block 410 is expressed as the following expressions (1) and (2).

$$\text{dx2} \text{=} \left[\text{H}\right] ⋅ \text{dx1}$$

$$\text{F2} \text{=} \left[\text{H}\right] ⋅ \text{F1}$$

In the expression (1), d is an operator that represents first derivative, dX2 is a velocity vector for deriving the state value of the velocity, dX1 is a vector, an element of which is the velocity (the velocity of the rotation axis of each of the actuators 109 to 112, or the velocity of a portion that operates in conjunction with the rotation axis of each of the actuators 109 to 112) based on the reference value and the actions of the actuators 109 to 112, and H is a conversion matrix that represents a bilateral function. In the expression (2), d²F2 (d² is an operator that represents second derivative) is a force vector for deriving the state value of the force, and d²F1 is a vector, an element of which is the force (the rotational torque of the rotation axis of each of the actuators 109 to 112, or the force of a portion that operates in conjunction with the rotation axis of each of the actuators 109 to 112) based on the reference value and the actions of the actuators 109 to 112.

As for the force/velocity distribution conversion block 410, coordinate transformation (that is, conversion from an oblique coordinate system into a rectangular coordinate system) of input data, elements of which are a position (velocity) and force related to each other in the real space into that in a virtual space in which the position (velocity) and the force are independent from each other is carried out, and calculation regarding the position (velocity) and calculation regarding the force can be independently made.

The ideal force origin block 420 makes calculation in a force domain in accordance with the coordinate transformation that is defined by the force/velocity distribution conversion block 410. As for the ideal force origin block 420, a target value regarding the force when calculation based on the coordinate transformation that is defined by the force/velocity distribution conversion block 410 is made is set. The target value is set as a fixed value or a variable value so as to correspond to a function (bilateral function) of transmitting the force tactile sensation that is performed by the master apparatuses 10 and the slave apparatuses 20. In the case where the force is scaled up or down, a coefficient in force scaling can be used for the coordinate transformation of the force/velocity distribution conversion block 410, conversion in the same scale can be maintained as for the force in the coordinate transformation of the force/velocity distribution conversion block 410, and the ideal force origin block 420 can set the target value of the scaled force.

The ideal velocity (position) origin block 430 makes calculation in a velocity (position) domain in accordance with the coordinate transformation that is defined by the force/velocity distribution conversion block 410. As for the ideal velocity (position) origin block 430, a target value regarding the velocity (position) when the calculation based on the coordinate transformation that is defined by the force/velocity distribution conversion block 410 is made is set. The target value is set as a fixed value or a variable value so as to correspond to the function (the bilateral function) of transmitting the force tactile sensation that is performed by the master apparatuses 10 and the slave apparatuses 20. In the case where the position is scaled up or down, a coefficient in position scaling can be used for the coordinate transformation of the force/velocity distribution conversion block 410, conversion in the same scale can be maintained as for the position in the coordinate transformation of the force/velocity distribution conversion block 410, and the ideal velocity (position) origin block 430 can set the target value of the scaled position.

The reverse conversion block 440 converts the values in the velocity (position) and force domains into values (for example, the value of voltage or the value of electric current) in a domain of an input into each actuator.

Consequently, when the information about the positions (the rotation angles of the rotors) of the actuators is inputted into the force/velocity distribution conversion block 410, information about the velocity (position) and the force that is acquired based on the information about the positions is used, and the force/velocity distribution conversion block 410 uses the control rule in the velocity (position) and force domains depending on the function (the bilateral function) of transmitting the force tactile sensation. The ideal force origin block 420 calculates the force depending on the function of transmitting the force tactile sensation, the ideal velocity (position) origin block 430 calculates the velocity (position) depending on the function of transmitting the force tactile sensation, and control energy is distributed to the force and the velocity (position).

The results of the calculation of the ideal force origin block 420 and the ideal velocity (position) origin block 430 correspond to information that represents a control target for each actuator, and the results of the calculation are used as input values into the actuator as for the reverse conversion block 440.

Consequently, each actuator operates in accordance with the function (the bilateral function) of transmitting the force tactile sensation that is defined by the force/velocity distribution conversion block 410, and the treatment operation is performed such that the force tactile sensation is transmitted between the master apparatuses 10 and the slave apparatuses 20.

Return to FIG. 5, the treatment-data-managing unit 155 acquires the control parameters in the treatment and the information about the user who is treated by the practitioner by using the master apparatus 10 and stores these in the treatment-data storage unit 171. The practitioner reads the information about the user that is stored in the treatment-data storage unit 171 and can consequently treat the user more appropriately when the same user is treated for the second time or later. In the case where the practitioner provides the treatment, the control parameters that are stored in the treatment-data storage unit 171 are partly or entirely transmitted to the control device 30, and the treatment operation that is performed by the practitioner can consequently be automatically repeated. For example, in the case where the pressing operation is performed on the left-hand shoulder after the pressing operation is performed on the right-hand shoulder, and the right-hand shoulder and the left-hand shoulder are treated again in the same manner, the control parameters that are stored in the treatment-data storage unit 171 are transmitted to the control device 30, and workload when the practitioner performs the same treatment operation can consequently be reduced.

### Functional Configuration of Slave Apparatus 20

FIG. 7 is a block diagram illustrating the functional configuration of each slave apparatus 20.

As for a CPU 811 of the slave apparatus 20 (the slave control unit 213), as illustrated in FIG. 7, a user interface control unit (a UI control unit) 251, a mode-setting unit 252, a sensor-information-acquiring unit 253, a force-tactile-sensation control unit 254, and a treatment-data-managing unit 255 function. A treatment-data storage unit 271 is formed in a storage unit 817 of the slave apparatus 20.

The treatment-data storage unit 271 stores the control parameters in the treatment and information about the practitioner who treats the user by using the slave apparatus 20. The information about the practitioner who treats the user includes attribution information such as the evaluation of the treatment technique, the contact address, the gender, the age, and the name of the practitioner. The control parameters in time series regarding the transmission of the force tactile sensation during the treatment of the practitioner are stored as the control parameters in the treatment.

The UI control unit 251 controls the display of various input and output screens in the process (the remote treatment process) for the practitioner who treats the user by using the position/force control system 1. For example, the UI control unit 251 receives the setting that represents whether the individual-treatment mode in which the practitioner treats the user in a one-to-one manner is activated, or the multiple-treatment mode in which the single practitioner treats multiple users is activated in the remote treatment process. In the case where the user sets the individual-treatment mode, the UI control unit 251 receives the selection of the practitioner whom the user wishes. The UI control unit 251 also receives an instruction for repeating the treatment operation from the user. The UI control unit 251 may cause a display of the output unit 816 to display the image (such as the image of the face that is captured in advance or an image that is captured in real time) of the practitioner who treats the user.

The mode-setting unit 252 sets the mode (the individual-treatment mode or the multiple-treatment mode) that is activated in the remote treatment process. The mode-setting unit 252 sets the individual-treatment mode or the multiple-treatment mode in accordance with an instruction from the user.

The sensor-information-acquiring unit 253 acquires information about positions (the rotation angles of rotors) that are detected by the rotary encoders 208a to 212a of the actuators 208 to 212. According to the present embodiment, the actuators 209 to 212 of the slave apparatus 20 involve in the transmission of the force tactile sensation, and accordingly, the sensor-information-acquiring unit 253 acquires the information about the positions (the rotation angles of the rotors) from the rotary encoders 209a to 212a at a rate that enables the treatment operation in the remote treatment process to be continuous and smooth, for example, in every 100 [ms]. The information about the positions (the rotation angles of the rotors) that is acquired from the rotary encoders 209a to 212a changes depending on the output (that is, an input from the practitioner into the master apparatus 10) of each actuator and a reaction when the right-hand pressing member 206R and the left-hand pressing member 206L act on the body of the user.

The force-tactile-sensation control unit 254 controls the transmission of the force tactile sensation, based on the information about the positions (the rotation angles of the rotors) that is acquired by the sensor-information-acquiring unit 253 and the information about the positions (the rotation angles of the rotors) in the actuators of the master apparatus 10 that is transmitted from the control device 30. That is, the force-tactile-sensation control unit 254 uses the information about the positions (the rotation angles of the rotors) in the actuators of the master apparatus 10 as the reference values and uses the reference values and the information about the positions (the rotation angles of the rotors) that is acquired by the sensor-information-acquiring unit 253 as input data, and causes a target actuator in the slave apparatus 20 to follow the operation (output of the position and the force) of the corresponding actuator in the master apparatus 10. As for the force-tactile-sensation control unit 254, an algorithm for the control over the transmission of the force tactile sensation is the same as the algorithm illustrated in FIG. 6.

The force-tactile-sensation control unit 254 has a fail-safe function for the slave apparatus 20. In the case where the control parameters for the force tactile sensation that exceed the upper limit values of various physical quantities (for example, the upper limit value of the force, the upper limit value of the velocity, and the upper limit value of displacement) are detected, the control over the transmission of the force tactile sensation to the master apparatus 10 is canceled, and control (control for inhibiting the action on the user) for urgently stopping the treatment unit 202 is autonomously implemented. The content of the control for urgently stopping the treatment unit 202 can be determined in advance. For example, while control for immediately stopping the treatment unit 202 or compliance control for the operation of the treatment unit 202 is used, control for movement to a predetermined retracted position (for example, a neutral position) at a low velocity, for example, can be implemented.

The treatment-data-managing unit 255 acquires the control parameters in the treatment and the information about the practitioner who treats the user by using the slave apparatus 20 and stores these in the treatment-data storage unit 271. The user reads the information about the practitioner that is stored in the treatment-data storage unit 271, selects the practitioner who provided the treatment in the past again, and can consequently be treated. In the case where the user is treated, the control parameters that are stored in the treatment-data storage unit 271 are partly or entirely read for execution, and the treatment operation that is performed by the practitioner can consequently be reproduced.

### Functional Configuration of Control Device 30

FIG. 8 is a block diagram illustrating the functional configuration of the control device 30.

As for a CPU 811 of the control device 30, as illustrated in FIG. 8, a request-receiving unit 351, a link-establishing unit 352, a force-tactile-sensation-transmission-managing unit 353, and a history-data-managing unit 354 function. A history database (a history DB) 371 is produced in a storage unit 817 of the control device 30.

The history DB 371 contains various kinds of data regarding the control over the transmission of the force tactile sensation that is implemented in the position/force control system 1. For example, the history DB 371 contains the information about the user who is treated by using the position/force control system 1, the information about the practitioner who provides the treatment, the control parameters that are set in the remote treatment process, information (such as a history in which the control parameters are reproduced and a history in which the force is adjusted) that is inputted into the slave apparatus 20 by the user, and information (such as a history in which the treatment operation is automatically repeated and a history in which the characteristics (such as the tendency of fatigue and precautions for the treatment) of the user who is treated are memorized) that is inputted into the master apparatus 10 by the practitioner.

The request-receiving unit 351 receives a request from the user who wishes to be treated in the remote treatment process. The request-receiving unit 351 selects the practitioner who can provide the treatment in the remote treatment process, in response to the request from the user or based on a predetermined selection standard. Examples of the predetermined selection standard include a standard (such as the gender or matching between the content of the treatment that the user wishes and the content of the treatment that the practitioner is good at) based on the attributes of the user and the attributes of the practitioner, a standard (such as equalization of the total treatment time of the practitioner) based on levelling of the workload of the practitioner, and a standard (such as a priority over a combination of the user and the practitioner who provided the treatment in the past) based on the history of the treatment.

The link-establishing unit 352 establishes a communication link between the slave apparatus 20 and the master apparatus 10 that performs the remote treatment process depending on the mode that is set by the user of the slave apparatus 20. That is, the link-establishing unit 352 establishes a link between the single slave apparatus 20 in the individual-treatment mode and the single master apparatus 10 in a one-to-one manner. Alternatively, the link-establishing unit 352 establishes links between multiple slave apparatuses 20 in the multiple-treatment mode and the single master apparatus 10 in a one-to-n manner (n is a natural number of 2 or more).

In the case where the remote treatment process is performed in the individual-treatment mode, the force-tactile-sensation-transmission-managing unit 353 controls (the bilateral control) the transmission of the force tactile sensation between the single slave apparatus 20 in the individual-treatment mode and the single master apparatus 10. At this time, the force-tactile-sensation-transmission-managing unit 353 can scale up or down the force that is outputted from the slave apparatus 20 in response to the request from the user of the slave apparatus 20.

In the case where the remote treatment process is performed in the multiple-treatment mode, the force-tactile-sensation-transmission-managing unit 353 normalizes the control parameters that are transmitted from the master apparatus 10 and transmits these to the slave apparatuses 20 of the users who are treated. For example, the force-tactile-sensation-transmission-managing unit 353 converts (normalizes) the control parameters that are transmitted from the master apparatus 10 into those for the treatment operation that is performed in the case where an imaginary user who has a standard body shape is treated and transmits these to the slave apparatuses 20 of the users who are treated. This enables the control parameters that can be shared and used by the multiple users to be transmitted to the slave apparatuses 20. The slave apparatuses 20 correct the normalized control parameters such that the control parameters are suitable for the users who are treated, and the force-tactile-sensation control unit 254 can control the transmission of the force tactile sensation. For example, the shoulder width and the thickness of muscle of each user are set in the slave apparatuses 20 in advance, the amount of correction based on a difference between the standard body shape and the body shape of the user is added into the control parameters, and the pressing operation can be outputted. The force-tactile-sensation-transmission-managing unit 353 may add the amount of correction based on the difference between the standard body shape and the body shape of the user into the control parameters and may transmit the corrected control parameters to the slave apparatuses 20. The normalized control parameters may not be corrected. Instead, as for the output of the force tactile sensation from the slave apparatuses 20, the weight of control over the force against control over the position may be increased, or only the control over the force may be implemented. The force tactile sensation similar to the adjusted force in the normalized control parameters is outputted with the result that the weight of the control over the force is increased. Accordingly, the treatment can be provided to a user who has a different body shape with the adjusted force that is the same as in the case where the standard body shape is treated by using the normalized control parameters.

The history-data-managing unit 354 stores various kinds of data regarding the control over the transmission of the force tactile sensation that is implemented in the position/force control system 1 in the history DB 371. The history-data-managing unit 354 can transmit history data that is stored in the history DB 371 to the master apparatuses 10 or the slave apparatuses 20, can identify the preference of each user by analyzing the data, and can evaluate the technique of each practitioner.

### Treatment Mode

The mode of the remote treatment process that is activated in the position/force control system 1 will now be described.

### Individual-Treatment Mode

FIG. 9 schematically illustrates the concept of the individual-treatment mode in the position/force control system 1.

The position/force control system 1 includes the multiple master apparatuses 10 and the multiple slave apparatuses 20. As illustrated in FIG. 9, the user of each slave apparatus 20 can set the individual-treatment mode in which the practitioner treats the user in a one-to-one manner.

In the individual-treatment mode, a communication link can be established between a freely selected one of the slave apparatuses 20 and a freely selected one of the master apparatuses 10, and the remote treatment process can be performed. For example, the user of the slave apparatus 20 selects a specific practitioner, or the control device 30 selects a practitioner from practitioners who can currently provide the treatment. This enables the transmission of the force tactile sensation between the master apparatus 10 and the slave apparatus 20 in a one-to-one manner to be controlled.

The individual-treatment mode enables detailed treatment to be provided while the practitioner checks the condition of the user by using an image that is displayed on, for example, the display device D. In the case where the remote treatment process is performed in the individual-treatment mode, the treatment can be provided while the user and the practitioner have a conversation by using microphones and speakers of the master apparatus 10 and the slave apparatus 20.

### Multiple-Treatment Mode

FIG. 10 schematically illustrates the concept of the multiple-treatment mode in the position/force control system 1.

The position/force control system 1 includes the multiple master apparatuses 10 and the multiple slave apparatuses 20. As illustrated in FIG. 10, the users of the slave apparatuses 20 can set the multiple-treatment mode in which the single practitioner treats the multiple users.

In the multiple-treatment mode, communication links can be established between the multiple slave apparatuses 20 and a specific one of the master apparatuses 10, and the remote treatment process can be performed. For example, when the practitioner who is evaluated as one who has a high treatment technique provides the treatment, the multiple users who wish to be treated by the practitioner participate in the treatment in the multiple-treatment mode, or the users participate in the treatment of the practitioner in the multiple-treatment mode in the case where there are no idle practitioners due to, for example, congestion, the transmission of the force tactile sensation between the specific single master apparatus 10 and the multiple slave apparatuses 20 is controlled.

The multiple-treatment mode enables the treatment of a popular practitioner to be provided to many users at the same time and enables a user who prioritizes the time zone of the treatment to be treated without an influence of the situation of congestion.

In the case where the remote treatment process is performed in the multiple-treatment mode, the control parameters that are transmitted from the master apparatus 10 are normalized and transmitted to the slave apparatuses 20 of the users to be treated, the slave apparatuses 20 correct the normalized control parameters such that the control parameters are suitable for the users to be treated, and the force-tactile-sensation control unit 254 can control the transmission of the force tactile sensation.

For this reason, the treatment appropriate for the body shape of each user can be provided also in the multiple-treatment mode.

### Operation

The operation of the position/force control system 1 will now be described.

FIG. 11 is a flowchart illustrating the flow of the remote treatment process that is performed by the position/force control system 1.

The control device 30 starts the remote treatment process in response to the input of an instruction for performing the remote treatment process.

After the remote treatment process starts, at a step S1, the request-receiving unit 351 of the control device 30 checks the practitioners who can currently provide the treatment. For example, the request-receiving unit 351 polls the master apparatuses 10 that are registered in the position/force control system 1 to check whether the master apparatuses 10 are running, the practitioners of the master apparatuses 10 that are running can be set as the practitioners who can currently provide the treatment. The practitioners who can currently provide the treatment can be checked in a manner in which the practitioners transmit, for example, a message that represents that the practitioners can provide the treatment from the master apparatuses 10 to the control device 30.

At a step S2, the request-receiving unit 351 receives the requests from the users who wish to be treated in the remote treatment process. At this time, the request-receiving unit 351 may transmit, for example, a list of the practitioners who can currently provide the treatment to the slave apparatuses 20, the users may refer the list, and the transmitted requests may be received.

At a step S3, the request-receiving unit 351 determines the mode in the requests from the slave apparatuses 20.

In the case where the individual-treatment mode is requested, the process proceeds to a step S4.

In the case where the multiple-treatment mode is requested, the process proceeds to a step S5.

In the case where both of the individual-treatment mode and the multiple-treatment mode are requested from the multiple slave apparatuses 20, the processes at the step S4 and the step S5 are performed in parallel.

At the step S4, the request-receiving unit 351 performs an individual-treatment process (see FIG. 12).

After the step S4, the remote treatment process is repeated.

At the step S5, the request-receiving unit 351 performs a multiple-treatment process (see FIG. 13).

After the step S5, the remote treatment process is repeated.

### Individual-Treatment Process

The individual-treatment process that is performed at the step S4 in the remote treatment process will now be described.

FIG. 12 is a flowchart illustrating the flow of the individual-treatment process.

The individual-treatment process is performed as a sub-flow at the step S4 in the remote treatment process.

After the individual-treatment process starts, at a step S11, the request-receiving unit 351 checks the practitioner who is selected by the user, based on the request that is received from the slave apparatus 20. Specifically, whether the data of the request contains information for the user to select the specific practitioner or contains information to freely select a practitioner (that is, whether information for selecting no practitioner is contained), for example, is determined.

At a step S12, the request-receiving unit 351 determines the practitioner who treats the user from the practitioners who can currently provide the treatment.

At a step S13, the link-establishing unit 352 establishes a communication link between the master apparatus 10 and the slave apparatus 20. Consequently, the transmission of the force tactile sensation between the master apparatus 10 of the practitioner who is determined at the step S12 and the slave apparatus 20 of the user can be controlled.

At a step S14, the force-tactile-sensation-transmission-managing unit 353 starts moving the master apparatus 10 and the slave apparatus 20 from the neutral positions to standard positions (initial positions depending on the body shape of the user). That is, the pressure-receiving unit 102 of the master apparatus 10 and the treatment unit 202 of the slave apparatus 20 start descending from the neutral positions (for example, the positions of upper ends in the up-down direction).

At a step S15, the force-tactile-sensation-transmission-managing unit 353 determines whether the treatment unit 202 comes into contact with the body of the user. That is, the slave control unit 213 of the slave apparatus 20 determines whether it is detected that predetermined reaction force acts on the treatment unit 202.

If the treatment unit 202 does not come into contact with the body of the user, the result of determination at the step S15 is NO, and the process at the step S15 is repeated.

If the treatment unit 202 comes into contact with the body of the user, the result of determination at the step S15 is YES, and the process proceeds to a step S16.

At the step S16, the force-tactile-sensation-transmission-managing unit 353 stops moving the master apparatus 10 and the slave apparatus 20 from the neutral positions. That is, the pressure-receiving unit 102 of the master apparatus 10 and the treatment unit 202 of the slave apparatus 20 stop moving. Positions at which these stop at the step S16 are set as the initial positions of the pressure-receiving unit 102 of the master apparatus 10 and the treatment unit 202 of the slave apparatus 20.

The processes at the step S14 to the step S16 may be performed by only the slave apparatus 20. The transmission of the force tactile sensation between the actuator 108 of the master apparatus 10 and the actuator 208 of the slave apparatus 20 may be controlled, the practitioner may manually move the pressure-receiving unit 102 of the master apparatus 10 and may stop these when the practitioner feels contact between the treatment unit 202 of the slave apparatus 20 and the user.

At a step S17, the force-tactile-sensation-transmission-managing unit 353 determines whether the practitioner imposes a restriction (for example, a pressing distance is restricted to a set value or less) on the movement of the pressure-receiving unit 102 of the master apparatus 10 and the treatment unit 202 of the slave apparatus 20 in the up-down direction in the master apparatuses 10. That is, when the practitioner provides the treatment, whether a restriction is imposed on the movement of the right-hand pressure-receiving member 106R and the left-hand pressure-receiving member 106L of the pressure-receiving unit 102 and the right-hand pressing member 206R and the left-hand pressing members 206L of the treatment unit 202 in the up-down direction is determined. The movement of the pressure-receiving unit 102 of the master apparatus 10 and the treatment unit 202 of the slave apparatus 20 in the up-down direction is thus restricted. Consequently, for example, the practitioner can avoid pressing the user too strongly with certainty.

If the practitioner does not impose the restriction on the movement of the pressure-receiving unit 102 of the master apparatus 10 and the treatment unit 202 of the slave apparatus 20 in the up-down direction, the result of determination at the step S17 is NO, and the process proceeds to a step S18.

If the practitioner imposes the restriction on the movement of the pressure-receiving unit 102 of the master apparatus 10 and the treatment unit 202 of the slave apparatus 20 in the up-down direction, the result of determination at the step S17 is YES, and the process proceeds to a step S19.

At the step S18, the force-tactile-sensation-transmission-managing unit 353 does not impose the restriction on the movement of the pressure-receiving unit 102 of the master apparatus 10 and the treatment unit 202 of the slave apparatus 20 in the up-down direction.

At the step S19, the force-tactile-sensation-transmission-managing unit 353 imposes the restriction on the movement of the pressure-receiving unit 102 of the master apparatus 10 and the treatment unit 202 of the slave apparatus 20 in the up-down direction.

At a step S20, the force-tactile-sensation-transmission-managing unit 353 starts controlling the transmission of the force tactile sensation (the bilateral control). Together with this, the history-data-managing unit 354 starts recording the control parameters regarding the control over the transmission of the force tactile sensation (sequentially stores the control parameters in the history DB 371). The control parameters regarding the control over the transmission of the force tactile sensation may be stored in the treatment-data storage unit 271 of the slave apparatus 20. An expiration date (for example, the current day only) may be set, and it may be permitted that the control parameters regarding the control over the transmission of the force tactile sensation are stored in the treatment-data storage unit 271 of the slave apparatus 20.

At a step S21, the force-tactile-sensation-transmission-managing unit 353 transmits the treatment operation that is inputted into the master apparatus 10 by the practitioner to the slave apparatus 20 and controls the transmission of the reaction force that is inputted from the body of the user in the slave apparatus 20 (controls the transmission of the force tactile sensation). In the case where the user is treated by using the slave apparatus 20, according to the present embodiment, the practitioner provides the first treatment on the current day by using the master apparatus 10, and the second or later treatment on the current day can be provided by reproducing the stored control parameters.

In the case where the process at the step S21 is performed, the force-tactile-sensation control unit 254 of the slave apparatus 20 monitors the control parameters that are transmitted from the control device 30 and the control parameters that are set in the slave apparatus 20. In the case where the control parameters for the force tactile sensation that exceed values (for example, the upper limit value of the force, the upper limit value of the velocity, and the upper limit value of the displacement) that are set as the upper limit of various physical quantities are detected, the force-tactile-sensation control unit 254 cancels the control over the transmission of the force tactile sensation to the master apparatus 10, and the control (the control for inhibiting the action on the user) for urgently stopping the treatment unit 202 is autonomously implemented.

At a step S22, the force-tactile-sensation-transmission-managing unit 353 receives notification (notification of the end of the treatment operation) that the input of the treatment operation from the master apparatus 10 ends. The notification of the end of the treatment operation is transmitted, for example, in a manner in which the practitioner operates the master apparatus 10 to end the treatment.

At a step S23, the UI control unit 251 of the slave apparatus 20 determines whether an instruction for repeating the treatment operation is inputted from the user.

If the instruction for repeating the treatment operation is not inputted from the user, the result of determination at the step S23 is NO, the individual-treatment process ends, and the process returns to the remote treatment process.

If the instruction for repeating the treatment operation is inputted from the user, the result of determination at the step S23 is YES, and the process proceeds to a step S24.

At the step S24, the treatment-data-managing unit 255 of the slave apparatus 20 saves the control parameters for the treatment operation that is repeated as a predetermined file in the treatment-data storage unit 271. The predetermined file that is saved at this time contains the control parameters for the treatment that the user wishes to repeat. For example, the control parameters for the entire treatment operation that is provided by the practitioner can be contained, or some control parameters that are selected by the user among those of the treatment operation that is provided by the practitioner can be contained.

At a step S25, the force-tactile-sensation-transmission-managing unit 353 reproduces the control parameters that are contained in the file that is saved at the step S24. Consequently, the treatment operation that the user wishes to repeat is reproduced, and the user can be treated without the treatment operation of the practitioner.

After the step S25, the slave apparatus 20 finishes reproducing the treatment operation (that is, an individual control process ends), and the process returns to the remote treatment process.

### Multiple-Treatment Process

The multiple-treatment process that is performed at the step S5 in the remote treatment process will now be described.

FIG. 13 is a flowchart illustrating the flow of the multiple-treatment process.

The multiple-treatment process is performed as a sub-flow at the step S5 in the remote treatment process.

After the multiple-treatment process starts, at a step S31, the request-receiving unit 351 checks the practitioner who is selected by the users, based on the requests that are received from the slave apparatuses 20. Specifically, whether the data of the request contains information for the users to select the specific practitioner or contains information to freely select a practitioner (that is, whether information for selecting no practitioner is contained), for example, is determined.

At a step S32, the request-receiving unit 351 determines the practitioner who treats the multiple users from the practitioners who can currently provide the treatment. That is, in the case where the specific practitioner who is selected by the users can currently provide the treatment, it is determined that the specific practitioner treats the multiple users. As for a user who freely selects the practitioner, the practitioner who is selected by the request-receiving unit 351, based on the predetermined selection standard among the practitioners who can currently provide the treatment is determined as the practitioner who provides the treatment.

At a step S33, the link-establishing unit 352 establishes communication links between the master apparatus 10 and the multiple slave apparatuses 20. Consequently, the transmission of the force tactile sensation between the master apparatus 10 of the practitioner who is determined at the step S32 and the slave apparatuses 20 of the multiple users can be controlled.

At a step S34, the force-tactile-sensation-transmission-managing unit 353 starts moving the master apparatus 10 and the multiple slave apparatuses 20 from the neutral positions to the standard positions (the initial positions depending on the body shapes of the users). That is, the pressure-receiving unit 102 of the master apparatus 10 and the treatment units 202 of the multiple slave apparatuses 20 start descending from the neutral positions (for example, the positions of the upper ends in the up-down direction).

At a step S35, the force-tactile-sensation-transmission-managing unit 353 determines whether the treatment unit 202 of each slave apparatus 20 comes into contact with the body of the user. That is, the slave control unit 213 of the slave apparatus 20 determines whether it is detected that the predetermined reaction force acts on the treatment unit 202.

If the treatment unit 202 does not come into contact with the body of the user, the result of determination at the step S35 is NO, and the process at the step S35 is repeated.

If the treatment unit 202 comes into contact with the body of the user, the result of determination at the step S35 is YES, and the process proceeds to a step S36.

At the step S36, the force-tactile-sensation-transmission-managing unit 353 stops moving the master apparatus 10 and the slave apparatuses 20 from the neutral positions. That is, the pressure-receiving unit 102 of the master apparatus 10 and the treatment units 202 of the slave apparatuses 20 stop moving. Positions at which these stop at the step S36 are set as the initial positions of the pressure-receiving unit 102 of the master apparatus 10 and the treatment units 202 of the slave apparatuses 20.

The processes at the step S34 to the step S36 can be performed in parallel by the slave apparatuses 20 to which the communication links are established. The processes at the step S34 to the step S36 may be performed by only the slave apparatuses 20.

At a step S37, the force-tactile-sensation-transmission-managing unit 353 starts controlling the transmission of the force tactile sensation (controlling the transmission of the force tactile sensation from the master apparatus 10 to the slave apparatuses 20). Together with this, the history-data-managing unit 354 starts recording the control parameters regarding the control over the transmission of the force tactile sensation (sequentially stores the control parameters in the history DB 371). The control parameters regarding the control over the transmission of the force tactile sensation may be stored in the treatment-data storage units 271 of the slave apparatuses 20. The expiration date (for example, the current day only) may be set, and it may be permitted that the control parameters regarding the control over the transmission of the force tactile sensation are stored in the treatment-data storage units 271 of the slave apparatuses 20.

At a step S38, the force-tactile-sensation-transmission-managing unit 353 controls the transmission of the force tactile sensation such that the treatment operation that is inputted by the practitioner into the master apparatus 10 is transmitted to the slave apparatuses 20. At this time, the force-tactile-sensation-transmission-managing unit 353 normalizes the control parameters that are transmitted from the master apparatus 10 and transmits the control parameters to the slave apparatuses 20 of the users to be treated. The slave apparatuses 20 correct the normalized control parameters such that the control parameters are suitable for the users to be treated, and the force-tactile-sensation control unit 254 can control the transmission of the force tactile sensation.

At a step S39, the force-tactile-sensation-transmission-managing unit 353 receives notification of the end of the treatment operation that represents the input of the treatment operation from the master apparatus 10 ends. The notification of the end of the treatment operation is transmitted, for example, in a manner in which the practitioner operates the master apparatus 10 to end the treatment.

At a step S40, the UI control units 251 of the slave apparatuses 20 determine whether the instruction for repeating the treatment operation is inputted from the users.

If the instruction for repeating the treatment operation is not inputted from the users, the result of determination at the step S40 is NO, the multiple-treatment process of the slave apparatuses 20 ends, and the process returns to the remote treatment process.

If the instruction for repeating the treatment operation is inputted from the users, the result of determination at the step S40 is YES, and the process proceeds to a step S41.

At the step S41, the treatment-data-managing units 255 of the slave apparatuses 20 save the control parameters for the treatment operation that is repeated as predetermined files in the treatment-data storage units 271. The predetermined files that are saved at this time contain the control parameters for the treatment that the users wish to repeat. For example, the control parameters for the entire treatment operation that is provided by the practitioner can be contained, or some control parameters that are selected by the users among those of the treatment operation that is provided by the practitioner can be contained. The control parameters that are saved at this time can be normalized control parameters that are transmitted from the master apparatus 10, or the slave apparatuses 20 can correct the normalized control parameters such that the control parameters are suitable for the users to be treated.

At a step S42, the force-tactile-sensation-transmission-managing unit 353 reproduces the control parameters that are contained in the files that are saved at the step S41. Consequently, the treatment operation that the users wish to repeat is reproduced, and the users can be treated without the treatment operation of the practitioner.

After the step S42, the slave apparatuses 20 finish reproducing the treatment operation (that is, a multiple-control process ends), and the process returns to the remote treatment process.

As for the position/force control system 1 according to the present embodiment, the multiple master apparatuses 10 and the multiple slave apparatuses 20 are remotely located, and a communication link can be established between a combination of a freely selected one of the master apparatuses 10 and a freely selected one of the slave apparatuses 20 as described above. The transmission of the force tactile sensation between the master apparatuses 10 and the slave apparatuses 20 is controlled, the treatment operations that are performed by the practitioners by using the master apparatuses 10 are consequently inputted into the users by using the slave apparatuses 20, and the reaction force that is inputted from the users into the slave apparatuses 20 is provided to the practitioners by using the master apparatuses 10.

Accordingly, a massage device can provide tactility similar to that in the case where the practitioners directly massage the users.

The treatment enables the autonomic nerve of the users to be steady and enables a relaxation effect to be expected for working, driving, learning, or an activity such as a hobby.

As for the position/force control system 1 according to the present embodiment, the control parameters for the treatment operations that are performed by the practitioners on the users by using the position/force control system 1 are stored, and the treatment operations can be partly or entirely reproduced automatically.

For this reason, it is easy for the users to repeatedly acquire the desired treatment operations, and the workload of the practitioners can be reduced because it is not necessary to repeat the same treatment operation.

As for the position/force control system 1, the remote treatment process can be performed in the individual-treatment mode in which the practitioner treats the user in a one-to-one manner and in the multiple-treatment mode in which the single practitioner treats the multiple users.

For this reason, the specific practitioner who is selected by the user or the practitioner who is selected by the position/force control system 1 can treats the user in a one-to-one manner in the individual-treatment mode, and accordingly, the detailed treatment can be provided while the condition of the user is checked.

The specific practitioner who is selected by the users or the practitioner who is selected by the position/force control system 1 can treat the multiple users at the same time in the multiple-treatment mode, and this enables the treatment of the popular practitioner to be provided to many users at the same time and enables the user who prioritizes the time zone of the treatment to be treated without the influence of the situation of congestion.

### First Modification

According to the embodiment described above, the mechanical structures of the master apparatuses 10 and the slave apparatuses 20 can be changed in various ways depending on the content of the treatment that is provided by the position/force control system 1.

FIG. 14 schematically illustrates the structure of the slave apparatus 20 that has a function of rubbing the back of the user. FIG. 15 is a front view of the slave apparatus 20 illustrated in FIG. 14. FIG. 16 is a sectional view of the slave apparatus 20 taken along line A-A′ in FIG. 15. FIG. 17 is a sectional view of the slave apparatus 20 taken along line B-B′ in FIG. 15.

The structure of the slave apparatus 20 illustrated in FIG. 14 to FIG. 17 differs from the structure of the slave apparatus 20 illustrated in FIG. 3 in including a right-hand rubbing portion 214R and a left-hand rubbing portion 214L that are movable in the front-rear direction and in the left-right direction.

The right-hand rubbing portion 214R is movable in the left-right direction with respect to the right-hand arm portion 204R and includes a right-hand support member 216R that supports a right-hand rubbing member 215R such that the right-hand rubbing member 215R is movable in the front-rear direction. The right-hand rubbing portion 214R is a member that performs a rubbing action on the user in accordance with the reference values of position and force that are transmitted from the control device 30 depending on the rubbing operation of the practitioner and moves in the front-rear direction with respect to the right-hand support member 216R. That is, the position of the right-hand rubbing portion 214R in the front-rear direction changes due to the rubbing operation of the practitioner.

The movement of the right-hand rubbing portion 214R in the left-right direction can be controlled by an actuator 217. The movement of the right-hand rubbing portion 214R in the front-rear direction can be controlled by an actuator 218. The actuators 217 and 218 include respective rotary encoders 217a and 218a that detect the rotation angles of rotors.

The left-hand rubbing portion 214L is movable in the left-right direction with respect to the left-hand arm portion 204L and includes a left-hand support member 216L that supports a left-hand rubbing member 215L such that the left-hand rubbing member 215L is movable in the front-rear direction. The left-hand rubbing portion 214L is a member that performs the rubbing action on the user in accordance with the reference values of position and force that are transmitted from the control device 30 depending on the rubbing operation of the practitioner and moves in the front-rear direction with respect to the left-hand support member 216L. That is, the position of the left-hand rubbing portion 214L in the front-rear direction changes due to the rubbing operation of the practitioner.

The movement of the left-hand rubbing portion 214L in the left-right direction can be controlled by an actuator 219. The movement of the left-hand rubbing portion 214L in the front-rear direction can be controlled by an actuator 220. The actuators 219 and 220 include respective rotary encoders 219a and 220a that detect the rotation angles of rotors.

Each master apparatus 10 has a structure for the rubbing action that corresponds to the right-hand rubbing portion 214R and the left-hand rubbing portion 214L as in the right-hand operation portion 105R and the left-hand operation portion 105L of the right-hand action portion 205R and the left-hand action portion 205L. The rubbing operation that the practitioner inputs by using the structure for the rubbing action can be transmitted to the user by using the right-hand rubbing portion 214R and the left-hand rubbing portion 214L of each slave apparatus 20 under the control over the transmission of the force tactile sensation. The master apparatus 10 may also include an operation portion (such as a controller that causes the right-hand rubbing portion 214R and the left-hand rubbing portion 214L to move in the up-down direction and in the left-right direction by using a lever) for enabling the right-hand operation portion 105R and the left-hand operation portion 105L to function as the structure for the rubbing action by changing settings or for remotely performing the rubbing operation of the right-hand rubbing portion 214R and the left-hand rubbing portion 214L.

With this structure, the rubbing operation of the right-hand rubbing portion 214R and the left-hand rubbing portion 214L can be performed as the treatment operation on the user in addition to the pressing operation of the right-hand pressing member 206R and the left-hand pressing member 206L.

In an example of the structure of the slave apparatus 20 illustrated in FIG. 14 to FIG. 17, the single right-hand rubbing portion 214R and the single left-hand rubbing portion 214L are included. However, multiple right-hand rubbing portions 214R and multiple left-hand rubbing portions 214L may be included.

The position/force control system 1 according to the present embodiment includes one or multiple master apparatuses 10 that receive the input of the treatment operations, one or multiple slave apparatuses 20 that output the treatment operations, and the control device 30 that controls the one or multiple master apparatuses 10 and the one or multiple slave apparatuses 20 as described above.

The control device 30 transmits the control parameters for causing the one or multiple slave apparatuses 20 to output the force tactile sensation that corresponds to the treatment operations that are inputted into the one or multiple master apparatuses 10 to the one or multiple slave apparatuses 20 and transmits the control parameters for causing the one or multiple master apparatuses 10 to output the reaction force against the treatment operations that are outputted by the one or multiple slave apparatuses 20 to the one or multiple master apparatuses 10.

Consequently, the treatment operations that are performed by the practitioners by using the one or multiple master apparatuses are inputted into the users by using the one or multiple slave apparatuses, and the reaction force that is inputted from the users into the one or multiple slave apparatuses is provided to the practitioners by using the one or multiple master apparatuses.

Accordingly, a massage device can provide tactility similar to that of massages in the cases where the practitioners directly treat the users.

The control device 30 establishes a communication link between one of the master apparatuses 10 and the slave apparatus 20 that makes a request in response to the request from the slave apparatus 20 and causes the force tactile sensation that corresponds to the treatment operation that is inputted into the master apparatus 10 to be outputted to the slave apparatus 20.

Consequently, the practitioner can provide the treatment in a one-to-one manner while the condition of the user is checked, and accordingly, the detailed treatment can be provided.

The control device 30 receives the requests from the multiple slave apparatuses 20 and establishes communication links between any one of the master apparatuses 10 and the multiple slave apparatuses 20 that make the requests.

Consequently, the treatment of the specific practitioner can be provided to many users at the same time, and the users can be treated without the influence of the situation of congestion about the practitioner.

The control device 30 establishes communication links between the single master apparatus 10 that is specified by the requests from the slave apparatuses 20 and the multiple slave apparatuses 20 that make the requests.

Consequently, the treatment of the practitioner that the users wish can be provided to the multiple users.

The control device 30 transmits the control parameters acquired by normalizing the treatment operation that is inputted into the master apparatus 10 to the multiple slave apparatuses 20.

Consequently, the control parameters that can be shared and used by the multiple users can be transmitted to the slave apparatuses 20.

The slave apparatuses 20 correct the normalized control parameters that are transmitted from the control device 30 depending on the users of the slave apparatuses 20 and output the force tactile sensation, based on the corrected control parameters.

Consequently, the treatment appropriate for the body shapes of the users can be provided also in the case where the single practitioner treats the multiple users.

In the case where a physical quantity that is represented by the control parameters that are transmitted from the control device 30 exceeds a predetermined upper limit, or in the case where a communication state in which the control parameters are received from the control device 30 becomes worse than a predetermined state, the slave apparatuses 20 implement predetermined control for inhibiting the action on the users.

Consequently, in the case where there is a possibility that the appropriate force tactile sensation is not provided to the users, inappropriate action can be inhibited from being inputted into the users.

The slave apparatuses 20 reproduce the stored control parameters and consequently output the force tactile sensation that corresponds to the treatment operation.

Consequently, the slave apparatuses 20 can reproduce the treatment operation that was performed in the past.

Each slave apparatus 20 includes the pressing members (the right-hand pressing member 206R and the left-hand pressing member 206L) that press the user who is treated and outputs the force tactile sensation of the pressing operation that is inputted into the master apparatus 10 by using the pressing members.

Consequently, the position/force control system 1 enables the treatment in which the user is pressed to be provided while the force tactile sensation is transmitted.

Each slave apparatus 20 includes the rubbing members (the right-hand rubbing portion 214R and the left-hand rubbing portion 214L) that rub the user who is treated and outputs the rubbing operation by using the rubbing members in response to an operation for the rubbing operation that is inputted into the master apparatus 10.

Consequently, the position/force control system 1 enables the treatment in which the user is rubbed to be provided while the force tactile sensation is transmitted.

Each slave apparatus 20 (a position/force control apparatus) according to the present embodiment is a position/force control apparatus that serves as a slave apparatus 20 of the position/force control system 1 that includes the one or multiple master apparatuses 10 that receive the input of the treatment operations, the one or multiple slave apparatuses 20 that output the treatment operations, and the control device 30 that controls the one or multiple master apparatuses 10 and the one or multiple slave apparatuses 20.

The slave apparatus 20 outputs the force tactile sensation that corresponds to the treatment operation, based on the control parameters that represent the force tactile sensation that corresponds to the treatment operation that is inputted into the master apparatus 10 that receives the input of the treatment operation.

Consequently, the slave apparatus 20 can output the treatment operation that is inputted into the master apparatus 10 in real time or the treatment operation that was performed in the past.

In an example described according to the embodiment, the control device 30 is separated from the master apparatuses 10 and the slave apparatuses 20 but is not limited thereto. That is, the master control unit 113 or the slave control unit 213 may have a part or the whole of the function of the control device 30, provided that the functional configurations of the control device 30, the master control unit 113, and the slave control unit 213 are included in the position/force control system 1. The control device 30 may have the functions of the master control unit 113 and the slave control unit 213, and the structures of the master apparatuses 10 and the slave apparatuses 20 may be simplified.

According to the embodiment described above, in the case where the slave apparatuses 20 detect the control parameters for the force tactile sensation that exceed the values (for example, the upper limit value of the force, the upper limit value of the velocity, and the upper limit value of the displacement) that are set as the upper limit of various physical quantities, fail-safe control is implemented, but this is not a limitation. That is, in the case where the communication state becomes worse than the predetermined state (such as disruption, reduction in velocity, and great variation in velocity), the slave apparatuses 20 may implement the fail-safe control.

The modification and the embodiment described above can be appropriately combined to carry out the present invention.

The process for control in the embodiment and the like may be performed through hardware or software.

That is, any configuration may be employed as long as a function for performing the process described above is provided for the position/force control system 1. The functional configuration and the hardware configuration for realizing the function are not limited to the examples described above.

When the process described above is performed through software, programs constituting the software are installed from a network or a storage medium to a computer.

The storage medium that stores the program is constituted by, for example, a removable medium that is distributed separately from the device body, or a storage medium that is previously built in the device body. The removable medium is constituted by, for example, a USB (Universal Serial Bus) flash drive, an SD card, a magnetic disk, an optical disc, or a magneto-optical disk. The optical disc is constituted by, for example, a CD-ROM (Compact Disk-Read Only Memory), a DVD (Digital Versatile Disk), or a Blu-ray Disc (trademark). The magneto-optical disk is constituted by, for example, a MD (Mini-Disk). The storage medium that is previously built in the device body is constituted by, for example, ROM or a hard disk in which the program is stored.

1. A position/force control system comprising:
one or multiple masterprimary apparatuses that receive an input of a treatment operation;
one or multiple secondary apparatuses that output a treatment operation; and
a controller that controls the one or multiple masterprimary apparatuses and the one or multiple secondary apparatuses,
wherein the controller transmits a control parameter for causing the one or multiple secondary apparatuses to output force tactile sensation that corresponds to the treatment operation that is inputted into the one or multiple masterprimary apparatuses to the one or multiple secondary apparatuses and transmits a control parameter for causing the one or multiple primary apparatuses to output reaction force against the treatment operation that is outputted by the one or multiple secondary apparatuses to the one or multiple primary apparatuses.

2. The position/force control system according to claim 1, wherein the controller establishes a communication link between the one masterprimary apparatus and the one secondary apparatus that makes a request in response to the request from the one secondary apparatus and causes the one secondary apparatus to output the force tactile sensation that corresponds to the treatment operation that is inputted into the one masterprimary apparatus.

3. The position/force control system according to claim 1, wherein the controller receives requests from the multiple secondary apparatuses and establishes communication links between the one masterprimary apparatus and the multiple secondary apparatuses that make the requests.

4. The position/force control system according to claim 3, wherein the controller establishes communication links between the one masterprimary apparatus that is specified by the requests from the multiple secondary apparatuses and the multiple secondary apparatuses that make the requests.

5. The position/force control system according to claim 3, wherein the controller transmits a control parameter acquired by normalizing the treatment operation that is inputted into the one primary apparatus to the multiple secondary apparatuses.

6. The position/force control system according to claim 5, wherein the multiple secondary apparatuses correct the normalized control parameter that is transmitted from the controller depending on a user of the multiple secondary apparatuses and output the force tactile sensation, based on the corrected control parameter.

7. The position/force control system according to claim 1, wherein at least in a case where a physical quantity that is represented by the control parameter that is transmitted from the controller exceeds a predetermined upper limit, or in a case where a communication state in which the control parameter is received from the controller becomes worse than a predetermined state, the one or multiple secondary apparatuses implement predetermined control for inhibiting an action on a user.

8. The position/force control system according to claim 1, wherein the one or multiple secondary apparatuses output the force tactile sensation that corresponds to the treatment operation by reproducing the control parameter that is stored.

9. The position/force control system according to claim 1, wherein the one or multiple secondary apparatuses include a pressing member that presses a user who is treated and outputs force tactile sensation of a pressing operation that is inputted into the one or multiple primary apparatuses by using the pressing member.

10. The position/force control system according to claim 1, wherein the one or multiple secondary apparatuses include a rubbing member that rubs a user who is treated and outputs a rubbing operation by using the rubbing member in response to an operation for a rubbing operation that is inputted into the one or multiple primary apparatuses.

11. A position/force control apparatus that serves as a secondary apparatus of a position/force control system that includes one or multiple primary apparatuses that receive an input of a treatment operation, one or multiple secondary apparatuses that output a treatment operation, and a controller that controls the one or multiple primary apparatuses and the one or multiple secondary apparatuses,
wherein force tactile sensation that corresponds to the treatment operation that is inputted into the one or multiple primary apparatuses that receive the input of the treatment operation is outputted based on a control parameter that represents the force tactile sensation that corresponds to the treatment operation.

12. A position/force control method that is performed by a position/force control system that includes one or multiple primary apparatuses that receive an input of a treatment operation, one or multiple secondary apparatuses that output a treatment operation, and a controller that controls the one or multiple primary apparatuses and the one or multiple secondary apparatuses, the method comprising:
transmitting, with the controller, a control parameter for causing the one or multiple secondary apparatuses to output force tactile sensation that corresponds to the treatment operation that is inputted into the one or multiple primary apparatuses to the one or multiple secondary apparatuses, and transmitting a control parameter for causing the one or multiple primary apparatuses to output reaction force against the treatment operation that is outputted by the one or multiple secondary apparatuses to the one or multiple primary apparatuses.

13. A position/force control method that is performed by a secondary apparatus of a position/force control system that includes one or multiple primary apparatuses that receive an input of a treatment operation, one or multiple secondary apparatuses that output a treatment operation, and a controller that controls the one or multiple primary apparatuses and the one or multiple secondary apparatuses, the method comprising:
outputting a force tactile sensation output at which force tactile sensation that corresponds to the treatment operation that is inputted into the one or multiple primary apparatuses that receive the input of the treatment operation is outputted based on a control parameter that represents the force tactile sensation that corresponds to the treatment operation.

14. A non-transitory computer-readable storage medium storing a program for causing a computer that includes a controller of a position/force control system that includes one or multiple primary apparatuses that receive an input of a treatment operation, one or multiple secondary apparatuses that output a treatment operation, and a controller that controls the one or multiple primary apparatuses and the one or multiple secondary apparatuses to fulfill a control function of transmitting a control parameter for causing the one or multiple secondary apparatuses to output force tactile sensation that corresponds to the treatment operation that is inputted into the one or multiple primary apparatuses to the one or multiple secondary apparatuses and transmitting a control parameter for causing the one or multiple primary apparatuses to output reaction force against the treatment operation that is outputted by the one or multiple secondary apparatuses to the one or multiple primary apparatuses.

15. A non-transitory computer-readable storage medium storing a program for causing a computer that includes a secondary apparatus of a position/force control system that includes one or multiple primary apparatuses that receive an input of a treatment operation, one or multiple secondary apparatuses that output a treatment operation, and a controller that controls the one or multiple primary apparatuses and the one or multiple secondary apparatuses to fulfill a force tactile sensation control function of outputting force tactile sensation that corresponds to the treatment operation that is inputted into the one or multiple primary apparatuses that receive the input of the treatment operation, based on a control parameter that represents the force tactile sensation that corresponds to the treatment operation.
